(19) United States
(12) Patent Application Publication
(10) Pub. No.: US 2019/0144244 A1
(43) Pub. Date: May 16, 2019

(54) CABLE AND STRUCTURE TRAVERSING TROLLEYS

(71) Applicant: TruBlue LLC, Boulder, CO (US)

(72) Inventor: John Lewis McGowan, Boulder, CO (US)

(21) Appl. No.: 16/188,625

(22) Filed: Nov. 13, 2018

Related U.S. Application Data
(60) Provisional application No. 62/585,842, filed on Nov. 14, 2017.

(51) Int. Cl. B66B 11/04; B66D 5/06; B66D 5/26; B66B 5/04; B66B 5/18; B66B 11/00

(52) U.S. Cl. CPC B66B 11/0438; B66D 5/06; B66D 5/26; B66C 7/00; B66B 5/18; B66B 11/0005; B66B 5/044

(57) ABSTRACT

A trolley includes a housing, at least one sheave rotatably mounted at least partially within the housing, and a braking mechanism. The braking mechanism includes a rotor assembly coupled to the at least one sheave, at least one conductive element, and at least one magnetic element. The rotor assembly is rotatable with the at least one sheave, and when the rotor assembly rotates, the at least one conductive element overlaps with the at least one magnetic element based at least in part on a rotational speed of the rotor assembly.

### CROSS-REFERENCE TO RELATED APPLICATIONS

This application claims priority to and the benefit of U.S. Provisional Patent Application No. 62/585,842, titled “CABLE AND STRUCTURE TRAVERSING TROLLEYS,” and filed Nov. 14, 2017, which is hereby incorporated by reference in its entirety.

### INTRODUCTION

Cable and structure traversing trolleys are utilized in industrial and amusement applications, whereby suspended static cables enable a load or user to descend, gravitationally, from an upper support structure to a lower support structure. For example, in amusement applications, zip lines, alternatively written as “ziplines” or “zip-lines,” refer to a form of entertainment in which a rider traverses a wire or other cable from one point to another. Typically, trolleys that support the load or rider are designed to reduce rolling resistance while traversing the cable. As such, the slope of the cable at least partially defines the descent speed of the trolley. Under these circumstances, the cable slope design parameters are relatively narrow. If the cable slope is too shallow (e.g., at a low angle), the trolley will not arrive at the terminal arrival point and will require recovery along the cable. Conversely, if the cable slope is too steep (e.g., at a high angle), the trolley will arrive at the terminal arrival point at a higher than desirable velocity. This may result in unwanted consequences, such as: injuries to riders, damages to loads, damage to trolleys, damage to braking components, increased braking force due to unintended consequences (such as trolleys lifting and creating drag on cables or other components), and/or lost efficiencies (such as loads not arriving at the intended location because of irregularities in braking requiring time to retrieve the load and place the system back into service). Accordingly, trolleys with integrated resistance mechanisms may be desirable when compared to those with minimal rolling resistance.

At least some known trolleys that service amusement applications employ braking systems designed to slow riders during descent. For example, some of these systems employ friction braking mechanisms that generate braking resistance in the form of drag, either applied to the cable itself or to the rolling sheaves of the trolley that interface with the cables. However, friction braking mechanisms may induce high wear to braking pads, sheaves, and/or the cables, thus requiring frequent component replacement. In addition, it can be difficult with friction braking mechanisms to provide predictable braking force with different loads (e.g., rider weight) and different conditions (e.g., cables can have a lower coefficient of friction when new (vs. old), lubricated (vs. unlubricated), wet (vs. dry), cold (vs. hot), icy (vs. dry), etc.). Examples of trolleys with frictional braking include: U.S. Pat. No. 6,622,634 to Cylvick, U.S. Pat. No. 6,666,773 to Richardson, U.S. Pat. No. 8,327,770 to Boren et al., U.S. Pat. No. 8,424,460 to Lerner et al., and U.S. Pat. No. 9,381,926 to Brannan.

### Cable and Structure Traversing Trolleys

This disclosure describes examples of load carrying trolleys with eddy current braking mechanisms. The eddy current braking mechanisms enable the descent of trolleys to be slowed on cables that would otherwise generate undesirable higher trolley velocities. Eddy current braking mechanisms function on the principle that when a conductor moves through a magnetic field (or vice-versa) the relative motion induces circulating eddies of electric current in the conductor. These current eddies in turn induce magnetic fields that oppose the effect of the applied magnetic field and act as a resistance (e.g., brake) on the movement of the conductor in the magnetic field (or vice-versa). Thus, eddy current braking mechanisms do not have components that contact each other and are advantageous over friction braking mechanism in that sacrificial components (e.g., friction brake pads) are eliminated and wear to cables and other hardware is reduced or eliminated.

In aspects, the eddy current braking mechanism is based at least in part on the centrifugal force generated by the rotation of one or more sheaves of the trolley as it traverses across the cable. These braking mechanisms enable for the resistance force generated by the braking mechanism to be dynamic (e.g., based at least partially on rotational speed) so that trolley speed along the cable is more constant across a wide variety of operating conditions (e.g., weight loads). In other aspects, the eddy current braking mechanism may generate a more constant resistance force so that the braking mechanism generates the same braking force for all trolleys and under all operating conditions. In either aspect, the trolley may include magnet and conductor configurations that increase the performance of the trolley. Furthermore, cooling features may be provided on the trolley to increase braking efficiencies.

In one aspect, the technology relates to a trolley including: a housing; at least one sheave rotatably mounted at least partially within the housing; and a braking mechanism including: a rotor assembly coupled to the at least one sheave; at least one conductive element; and at least one magnetic element, wherein the rotor assembly is rotatable with the at least one sheave, and wherein when the rotor assembly rotates, the at least one conductive element overlaps with the at least one magnetic element based at least in part on a rotational speed of the rotor assembly.

In an example, the trolley further includes a sheave axle that directly couples rotation of the at least one sheave to the rotor assembly. In another example, a transmission is coupled between the at least one sheave and the rotor assembly, the transmission either increases or decreases the rotation of the rotor assembly from the rotation of the at least one sheave. In still another example, the braking mechanism is at least partially disposed within the housing. In yet another example, at least a portion of the braking mechanism is disposed at least partially within the at least one sheave. In an example, the rotor assembly is disposed at least partially within the at least one sheave and includes the at least one magnetic element.

In another example, the housing includes the at least one conductive element. In still another example, the rotor assembly is disposed at least partially within the at least one sheave and includes the at least one conductive element. In yet another example, the trolley further includes a heat sink. In an example, the rotor assembly includes one or more pivoting arms having the at least one conductive element or the at least one magnetic element, and the pivoting arms include one or more cavities defined therein. In another example, the rotor assembly includes one or more pivoting arms having the at least one conductive element or the at least one magnetic element, and the pivoting arms include one or more slots defined therein.

In another aspect, the technology relates to a trolley including: a housing; at least one sheave rotatably mounted at least partially within the housing; and a braking mechanism including: at least one magnetic element coupled to the at least one sheave, wherein the at least one magnetic element is rotatable with the at least one sheave; and at least one conductive element disposed proximate the at least one magnetic element.

In an example, the housing includes the at least one conductive element. In another example, the at least one sheave includes a plurality of circumferentially spaced cavities defined in a sidewall, and each cavity of the plurality of cavities is sized and shaped to receive the at least one magnetic element. In yet another example, at least one cavity of the plurality of cavities is devoid of the at least one magnetic element. In still another example, the at least one magnetic element includes a first magnetic element and a second magnetic element, and the first magnetic element has a greater magnetic strength than the second magnetic element. In an example, the plurality of cavities include a first cavity and a second cavity, and the first cavity includes a depth within the sidewall greater than a depth of the second cavity.

In another aspect, the technology relates to an eddy current braking mechanism including: a structure including at least one conductive element or at least one magnetic element; and a trolley configured to traverse along the cable, the trolley including: a housing; at least one sheave rotatably mounted at least partially within the housing; and the other of the at least one conductive element or the at least one magnetic element, wherein the at least one conductive element is proximate the at least one magnetic element, when the trolley is installed onto the cable.

In an example, the trolley further includes an adjustment device that selectively positions the at least one magnetic element relative to the at least one conductive element. In another example, the at least one conductive element or the least one magnetic element is coupled to the structure.

These and various other features as well as advantages that characterize the trolleys described herein will be apparent from a reading of the following detailed description and a review of the associated drawings. Additional features are set forth in the description which follows, and in part will be apparent from the description, or may be learned by practice of the technology. The benefits and features of the technology will be realized and attained by the structure particularly pointed out in the written description and claims hereof as well as the appended drawings.

It is to be understood that both the foregoing introduction and the following detailed description are exemplary and explanatory and are intended to provide further explanation of the invention as claimed.

### BRIEF DESCRIPTION OF THE DRAWINGS

The following drawing figures, which form a part of this application, are illustrative of described technology and are not meant to limit the scope of the invention as claimed in any manner, which scope shall be based on the claims appended hereto.

FIG. 1A is a side perspective view of an exemplary trolley.

FIG. 1B is another side perspective view of the trolley shown in FIG. 1A.

FIG. 2 is the side perspective view of the trolley shown in FIG. 1B with a portion of a braking mechanism housing removed.

FIG. 3 is a front view of a rotor assembly for a braking mechanism.

FIG. 4A is a perspective view of a pivoting arm for a braking mechanism.

FIG. 4B is a perspective view of another pivoting arm for a braking mechanism.

FIG. 5 is a side view of another trolley.

FIG. 6 is a perspective view of another trolley.

FIG. 7A is a perspective view of another trolley.

FIG. 7B is a side view of the trolley shown in FIG. 7A.

FIG. 8 is a perspective view of a sheave of the trolley shown in FIGS. 7A and 7B.

FIG. 9 is a perspective view of another trolley.

FIG. 10A is a perspective view of another trolley.

FIG. 10B is a side view of the trolley shown in FIG. 10A.

FIG. 11 is a perspective view of a sheave of the trolley shown in FIGS. 10A and 10B.

FIG. 12A is a perspective view of another trolley.

FIG. 12B is a front view of the trolley shown in FIG. 12A.

FIG. 13A is an exploded perspective view of another trolley.

FIG. 13B is a perspective view of a sheave of the trolley shown in FIG. 13A.

### DETAILED DESCRIPTION

This disclosure describes examples of load carrying trolleys with eddy current braking mechanisms. In aspects, the eddy current braking mechanism is based at least in part on the centrifugal force generated by the rotation of one or more sheaves of the trolley as it traverses across the cable. These braking mechanisms enable for the resistance force generated by the braking mechanism to be dynamic (e.g., based at least partially on rotational speed) so that trolley speed along the cable is more constant across a wide variety of operating conditions (e.g., weight loads). In other aspects, the eddy current braking mechanism may generate a more constant resistance force so that the braking mechanism generates the same braking force for all trolleys and under all operating conditions. In either aspect, the trolley may include magnet and conductor configurations that increase the performance of the trolley. For example, a housing of the trolley may be formed as the conductive element of the braking mechanism. In another example, a transmission may be used to increase or decrease the rotational speed of the eddy current rotor. In yet another example, at least a portion of the braking mechanism may be disposed within the sheaves of the trolley. Furthermore, cooling features may be provided on the trolley to increase braking efficiencies.

Throughout this description, references to orientation (e.g., front(ward), rear(ward), top, bottom, back, right, left, upper, lower, etc.) of the trolley relate to its position when installed on a cable and are used for ease of description and illustration only. No restriction is intended by use of the terms regardless of how the trolley is situated on its own. Furthermore, the examples disclosed herein will be described in terms of use in a cable and structure traversing trolley. It is understood that the mechanisms described herein could be adapted to any number of devices and used beyond those presented, including, but not limited to, trolleys that traverse structural members (e.g., rails or tubes).

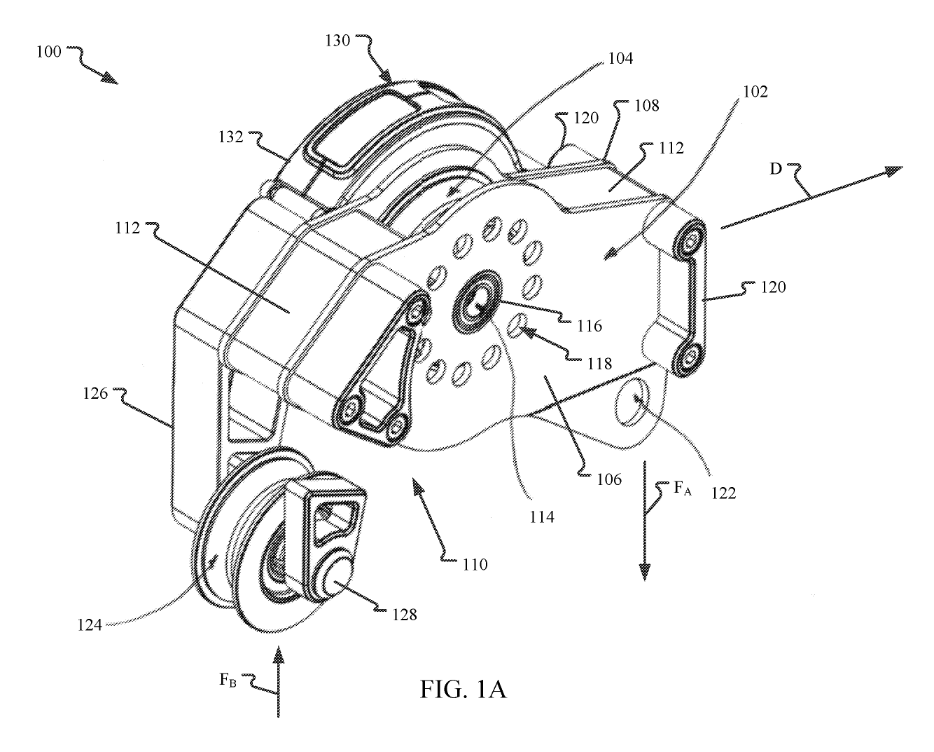

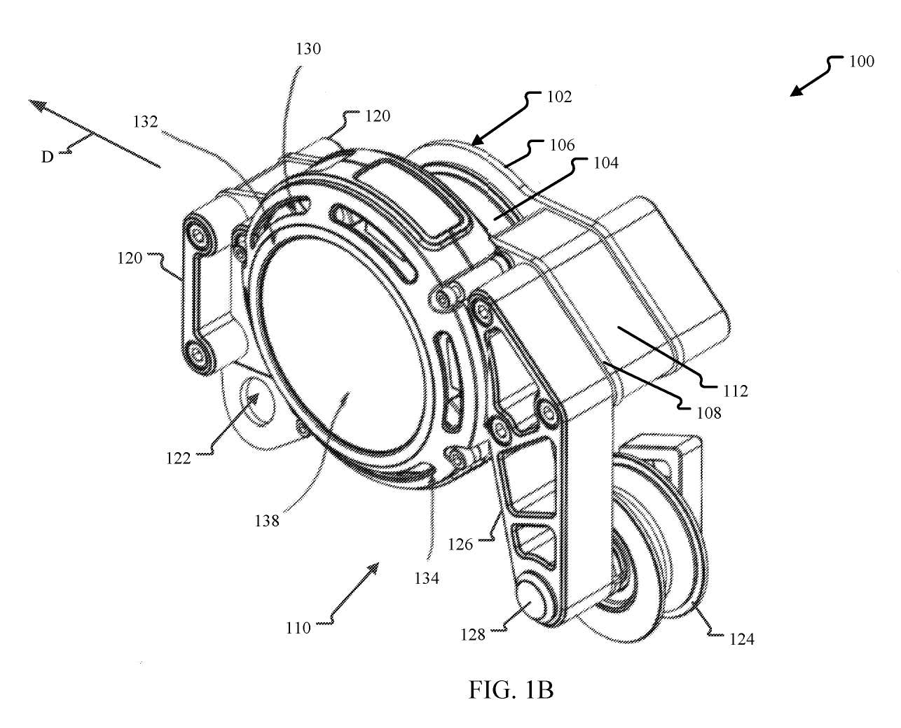

FIG. 1A is a side perspective view of an exemplary trolley 100. FIG. 1B is another side perspective view of the trolley 100. Referring concurrently to FIGS. 1A and 1B, the trolley 100 is configured to engage with a cable (not shown) and traverse along the cable in a forward direction D. The trolley 100 includes a housing 102 that rotatably supports a drive sheave 104 at least partially therein. The housing 102 may be formed by a pair of opposing side plates 106, 108 with the drive sheave 104 disposed between. The side plates 106, 108 are wide enough apart to accommodate the cable or other structure and allow the trolley 100 to be placed on (e.g., installed) and removed from the cable via a bottom opening 110. One or more inserts 112 may be coupled between the side plates 106, 108 and at least partially correspond to the outer perimeter shape of the side plates 106, 108. The inserts 112 may at least partially enclose the drive sheave 104 with the side plates 106, 108 so as to reduce dirt and debris accumulation, to restrict access to the drive sheave 104, and/or to increase overall durability of the trolley 100.

The drive sheave 104 is coupled to a drive sheave axle 114 such that rotation of the drive sheave 104 drives corresponding rotation of the drive sheave axle 114. The drive sheave axle 114 is rotationally supported between the side plates 106, 108 by bearings 116. One or more of the side plates 106, 108 may include one or more vent openings 118 positioned proximate the drive sheave 104 so that the sheaves may be air cooled during operation. The vent openings 118 may be any shape, size, and/or configuration as required or desired. The trolley 100 is configured to be installed onto the cable such that the drive sheave 104 engages the cable from above and the drive sheave axle 114 is disposed above the cable.

On the front portion of the trolley 100, a bumper 120 extends from one or more of the side plates 106, 108. Additionally, on the front portion of the trolley 100, an anchor point 122 is defined on one or more of the side plates 106, 108. In the example, the anchor point 122 is a substantially circular aperture that is sized and shaped to support the rider or other payload, for example, receive a webbing, a carabiner, or the like connection element that supports the rider or other payload. The anchor point 122 is disposed on the trolley 100 such that when the trolley 100 is installed onto the cable, the anchor point 122 is located below the cable. As such, the anchor point 122 is located forward (based on the direction of travel D) of the drive sheave 104, and also, below the drive sheave 104. In one example, the anchor point 122 is completely forward of the drive sheave 104 so that no portion of the anchor point 122 is located underneath the drive sheave 104. In another example, the anchor point 122 may be forward of the drive sheave axle 114 so that a portion of the anchor point 122 may be located underneath or at least partially underneath the drive sheave 104.

Opposite of the bumper 120 and the anchor point 122, and on the rear portion of the trolley 100, an opposition sheave 124 extends below the housing 102. An arm 126 extends from one or more of the side plates 106, 108 and rotatably supports the opposition sheave 124. When the trolley 100 is installed on the cable, the opposition sheave 124 engages the cable from below so that the cable is positioned between the drive sheave 104 and the opposition sheave 124. The sheave 124 rotates about an axle 128 that is positioned below the cable with the trolley 100 is installed thereon and rearward of the drive sheave 104. In one example, the axle 128 may be aligned with the anchor point 122 when the trolley 100 is installed on the cable (e.g., both being approximately the same distance below). In other examples, the axle 128 may be closer to, or further away from, the cable than the anchor point 122, when the trolley 100 is installed on the cable. In another example, the axle 128 may be positioned rearward from the drive sheave 104 at approximately the same distance as the anchor point 122 is positioned forward of the drive sheave 104 (e.g., along the travel direction D). In other examples, the axle 128 may be closer to, or further away from, the drive sheave 104 than the anchor point 122 relative to the drive sheave 104 along the travel direction D.

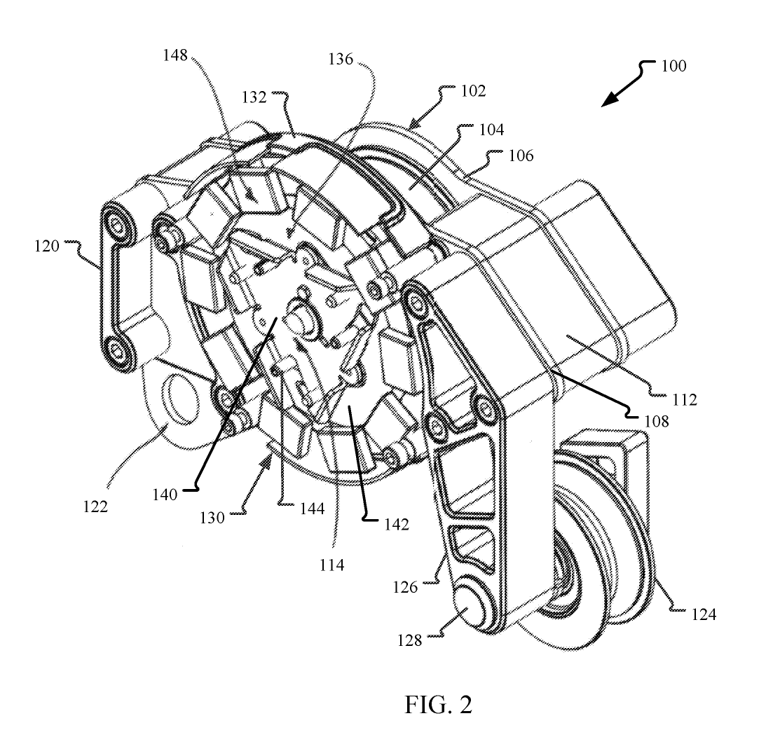

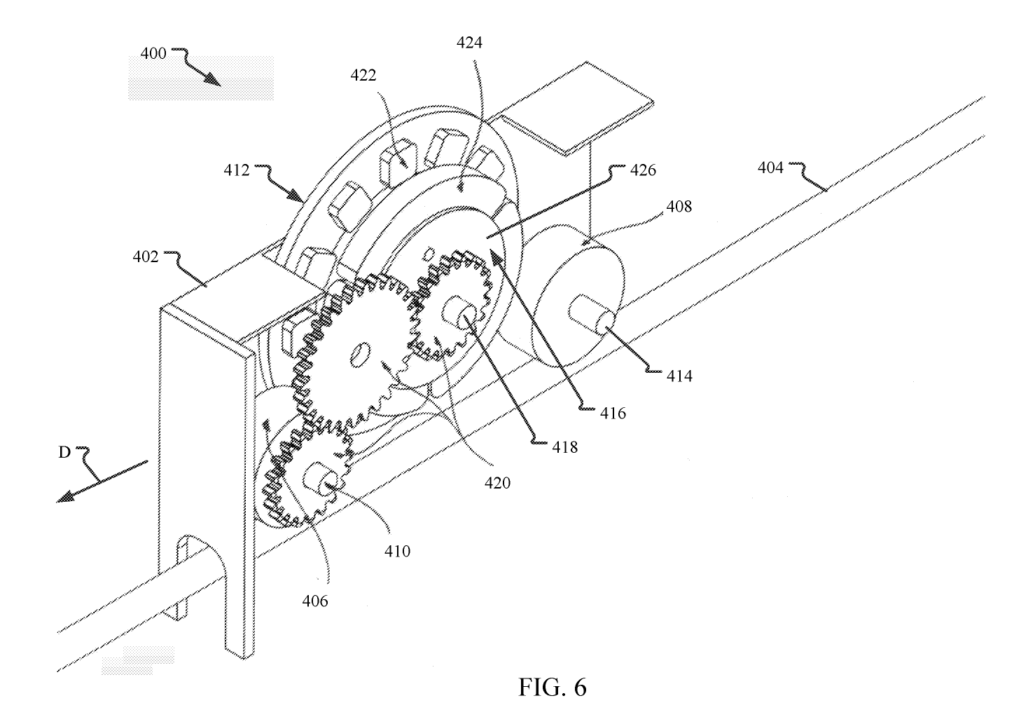

Coupled to one side of the housing 102 (e.g., the side plate 108) is an eddy current braking mechanism 130. In the example, the braking mechanism 130 includes a housing 132 with one or more vent openings 134 and that houses a rotor assembly 136 (shown in FIG. 2) having one or more conductive elements, with one or more magnetic elements disposed proximate the rotor assembly 136. The rotor assembly 136 is coupled to the drive sheave axle 114 so that rotation of the drive sheave 104 (e.g., via traversing along the cable) induces corresponding rotation of the rotor assembly 136. In the example, the drive sheave 104 may be directly coupled to the rotor assembly 136 so that every sheave revolution approximately equals rotation of the rotor assembly 136 such that there is a 1:1 drive ratio. In other examples, a transmission may be coupled between the drive sheave 104 and the rotor assembly 136 so that every sheave revolution does not equal rotation of the rotor assembly 136 such that there is either a higher (e.g., more rotation) or lower (e.g., less rotation) drive ratio. The transmission is described further below in reference to FIG. 6 and by controlling the rotational speed of the rotor assembly 136 breaking efficiencies of the braking mechanism 130 are increased.

In operation, as the trolley 100 traverses the cable, the braking mechanism 130 generates an eddy current resistance force to selectively apply a braking force to the drive sheave 104, via the drive sheave axle 114, and reduce the speed of the trolley 100. Because the eddy current braking force applies the braking force to the drive sheave 104, it is desirable to increase the frictional engagement between the drive sheave 104 and the cable so that the speed of the trolley 100 can be reduced without the drive sheave 104 slipping relative to the cable. If the drive sheave 104 is not engaged with the cable, then any braking force applied to the drive sheave 104 may not reduce the speed of the trolley 100. As such, in the example, the drive sheave 104 and/or the opposition sheave 124 may be at least partially formed from a resilient elastomer material so as to increase the friction between the sheaves 104, 124 and the cable (e.g., increase the grip of the sheaves 104, 124). In one example, the portion of the sheaves 104, 124 that contact the cable can be formed from a polyurethane material. In another example, the portion of the sheaves 104, 124 that contact the cable may be textured (e.g., surface features or preparations) to augment traction thereof. Additionally or alternatively, any other material or surface formation may be used that enable the function of the sheaves 104, 124 as described herein.

Furthermore, the trolley 100 itself is configured so as to increase engagement with the cable. In the example, the trolley 100 can be installed onto the cable such that the drive sheave 104 engages the cable from above and the opposition sheave 124 engages the cable from below. In this configuration, when a rider or a load is secured to the anchor point 122, the majority of the load is supported by the drive sheave 104 so as to increase its frictional engagement with the cable. Additionally, since the anchor point 122 is offset from the drive sheave 104, the resulting force FA (shown in FIG. 1A) induces a downward rotation of the front portion of the trolley 100 about the drive sheave axle 114. By rotating the front portion of the trolley 100 in a downwards direction, the rear portion of the trolley 100 rotates in a corresponding upwards direction so that the opposition sheave 124 engages with the underside of the cable with a corresponding force FB (shown in FIG. 1A). This engagement of the opposition sheave 124 with the cable further prevents the drive sheave 104 from lifting off of the cable and further increases its frictional engagement with the cable. Accordingly, the trolley 100 is configured to reduce the sheaves 104, 124 slipping on the cable when the eddy current braking force is applied. In examples where the anchor point 122 is positioned further away from the drive shave than the axle 128 (along the travel direction D), the force FB increases, thereby increasing the frictional engagement between the trolley 100 and the cable.

Additionally or alternatively, other trolley 100 configurations may be used so as to increase drive sheave 104 frictional engagement with the cable. In one example, two or more sheaves may be placed above the cable and one or more opposition sheaves may be placed below the cable. In another example, one or more sheaves may be tensioned against opposing sheaves by a tensioning mechanism, such as a threaded tensioner, a spring-loaded tensioner, and/or a quick-release tensioner. In still another example, the drive sheave 104 may be one or more sheave, positioned either above or below the cable. In yet other examples, one or more of the trolley configurations disclosed in U.S. Patent Application Publication 2015/0266454 to McGowan, published Sep. 24, 2015, entitled “CABLE-TRAVERSING TROLLEY ADAPTED FOR USE WITH IMPACT BRAKING,” and which is hereby incorporated by reference in its entirety, may be used as required or desired.

During operation of the trolley 100 (e.g., from the rotating components and/or the increased frictional engagement with the cable), the trolley 100 may undesirably increase in temperature. This heating of the trolley 100 and the trolley components may undesirably affect performance of the trolley 100. For example, increased heat may increase wear on the bearings 116, the sheaves 104, 124, and/or the braking mechanism 130 (e.g., heat reduces the magnetic field generated by the conductor, thus reducing braking efficiencies). As such, the vent openings 118 are positioned adjacent to the drive sheave 104 so that coolant air flow may be channeled directly to the sheave 104. The braking mechanism housing 132 may also include vent openings 134 that enable coolant air flow to be channeled into the braking mechanism 130 and cool the components therein. As illustrated, the vent openings 134 are circumferentially spaced around the housing 132, however, openings 134 may additionally or alternatively be defined in a face 138 of the housing 132. In some examples, the openings 118, 134 may be sized and shaped (e.g., a scoop) to increase air flow through the trolley 100 as the trolley moves along the cable. Additionally or alternatively, a fan (e.g., one or more blades coupled to a rotatable component) may be used to channel air flow to components of the trolley 100 for cooling (e.g., the sheave 104 and/or the braking mechanism 130). As described herein, the vent openings, fans, scoops, etc. may be used to channel a coolant air flow to the trolley components and/or may be used to channel a flow of heated air away from the trolley components and expel out of the trolley 100. Furthermore, additionally or alternatively, other heat dissipation systems can be used as required or desired. For example, heat sinks may be coupled to trolley components so as to increase the surface area thereof, trolley components may be milled and/or grooved to increase the surface area thereof, and/or micro-relief or coatings may be applied to surfaces to increase surface area and heat transfer.

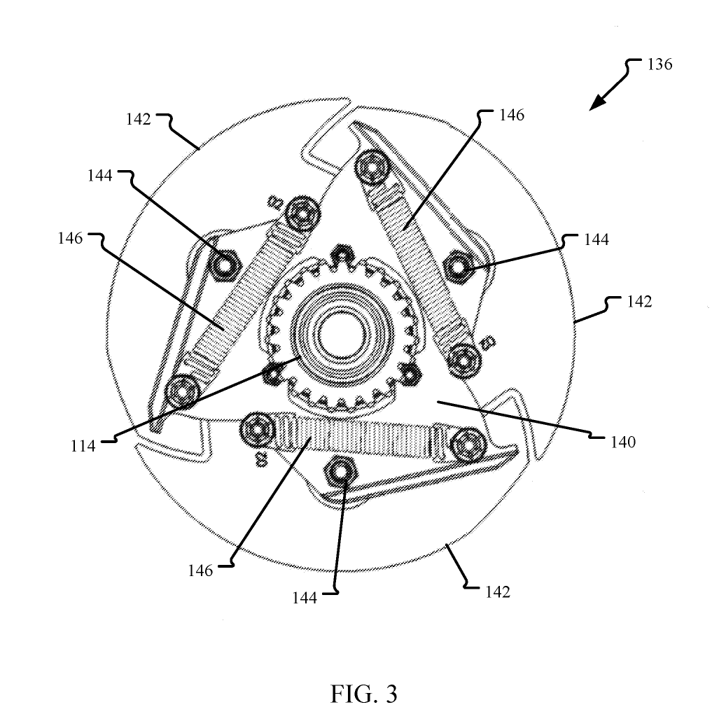

FIG. 2 is a perspective view of the trolley 100 with a portion of the braking mechanism housing 132 removed. A number of components of the trolley 100 are described above with regards to FIGS. 1A and 1B and, as such, are not necessarily described further. The braking mechanism 130 is a centrifugal type eddy current braking mechanism disposed within the housing 132 and it is at least partially coupled to the drive sheave axle 114. More specifically, the rotor assembly 136 includes a rotor 140 that is coupled to the drive sheave axle 114. One or more pivoting arms 142 are coupled to the rotor 140 at a pivot point 144 and biased by a spring 146 (shown in FIG. 3). In the example, the pivoting arms 142 are formed from a conductive material. Additionally, the braking mechanism 130 includes one or more magnets 148 circumferentially spaced around an outer perimeter of the rotor assembly 136 and supported by the housing 132. In the example, the magnets 148 are in an array on both sides of the rotor assembly 136. However, in other examples, the magnets 148 may be positioned only on one side of the rotor assembly 136 as required or desired (e.g., due to space and/or cost considerations). The rotor assembly 136 is illustrated in further detail in FIG. 3 and described further below.

In operation, the braking mechanism 130 provides a centrifugal eddy current braking force to the drive sheave 104. That is, as the drive sheave 104 rotates when the trolley 100 is traversing along the cable, the drive sheave axle 114 rotates. As the axle 114 rotates with increasing velocity, the pivoting arms 142 of the rotor assembly 136 radially deflect into the magnetic field generated by the magnets 148, thereby generating eddy current resistance and a braking force on the drive sheave axle 114. Because the distance that the conductors (e.g., the pivoting arms 142) extend into an overlap position with the magnets 148 is dependent on the centrifugal force induced by the rotation of the rotor assembly 136, the braking force is variable with respect to the rotational speed of the drive sheave 104. As such, the trolley 100 traversing along a sloped cable will have approximately the same speed with a heaver load attached and with a lighter load attached, without any changes to the braking mechanism 130. In some examples, the springs 146 may be configured so as to only allow extension of the pivoting arms 142 once the rotational velocity of the rotor assembly 136 exceeds a predetermined revolution per minute (rpm). With this, eddy current braking force is eliminated when a trolley velocity falls under a predetermined speed. An example of a centrifugal eddy current braking mechanism 130 is described in greater detail in U.S. Pat. No. 8,851,235 to Allington et al., granted Oct. 7, 2014, entitled “BRAKING MECHANISMS,” and which is hereby incorporated by reference in its entirety.

By having the trolley 100 with the variable braking mechanism 130 described above, a singular trolley that serves all load weights can be inventoried by an operator, rather than multiple trolley configurations (e.g., each for different weight ranges), thereby decreasing capital costs. Furthermore, the eddy current braking mechanism 130 enables the trolley 100 to be designed without any sacrificial components and will reduce wear on the cable or structure (e.g., due to friction braking).

In comparison, some known trolleys with eddy current braking mechanisms provide a constant (e.g., fixed) level of braking force, regardless of the load or weight of the rider. This results in some level of braking force being generated under all velocities. As such, these systems apply more braking force to a light weight rider than a heavier rider. For example, a trolley configured for a heavy rider might enable the rider to arrive at the terminal arrival point with the desired velocity, whereas a lighter rider on the same trolley would stop well short of the terminal arrival point. Accordingly, zip line operators need to use a broad range of trolleys, each with different fixed resistance properties, to ensure that riders of different weights arrive at the correct location with the correct velocity. Additionally or alternatively, each rider might need to be weighed so as to select the correct trolley braking range. Examples of zip line trolleys with fixed eddy current braking include: U.S. Pat. No. 8,601,951 to Lerner and U.S. Pat. No. 9,242,659 to Bernier.

FIG. 3 is a front view of the rotor assembly 136 for the braking mechanism 130 (shown in FIG. 2). The rotor assembly 136 includes the rotor 140 that is coupled to the drive sheave axle 114 so that rotation is driven thereof. The pivoting arms 142 are pivotably coupled to the rotor 140 at pivot points 144. Additionally, the pivoting arms 142 are biased in the retracted position (as illustrated in FIG. 3) by the spring 146 that extends between a portion of the pivoting arms 142 and the rotor 140. The operation of the rotor assembly 136 is described in greater detail in U.S. Pat. No. 8,851,235 to Allington et al., granted Oct. 7, 2014, entitled “BRAKING MECHANISMS,” and which is hereby incorporated by reference in its entirety.

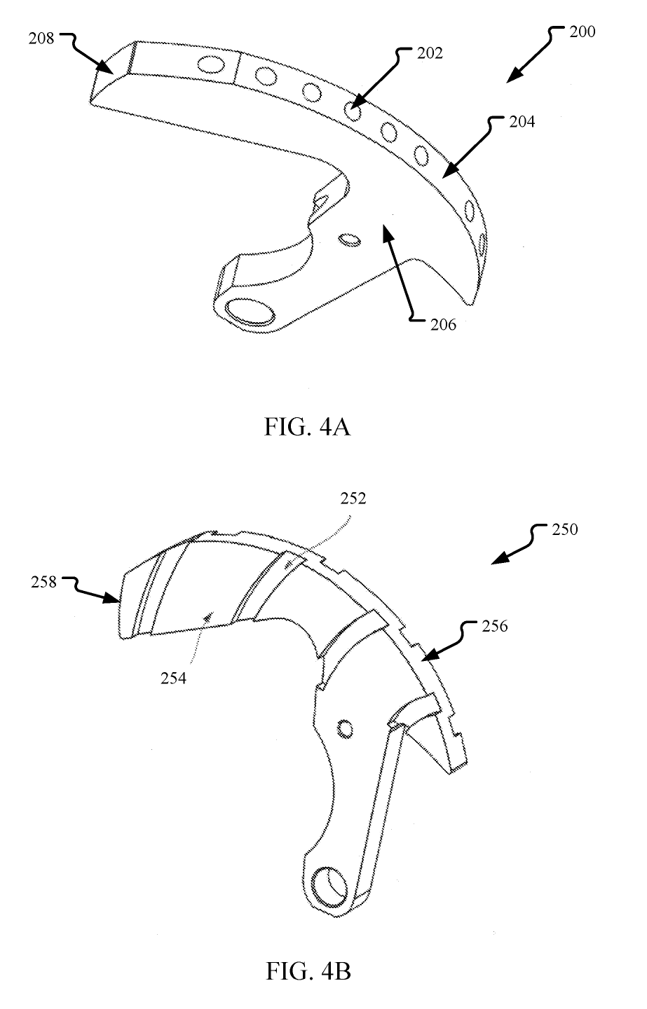

FIG. 4A is a perspective view of a pivoting arm 200 for the braking mechanism 130 (shown in FIG. 2). As described above, during operation of the trolley 100 (shown in FIGS. 1A-2) one or more components may increase in temperature. For the conductive elements (e.g., the pivoting arm 200) of the braking mechanism 130, increased heat may reduce the magnetic field generated by the conductor, and thus, reducing braking efficiencies. As such, the pivoting arm 200 may include one or more cavities 202 that increase the surface area of the pivoting arm 200 to increase heat dissipation during operation. The pivoting arm 200 includes an outer surface 204 that forms the outer most circumferential surface of the rotor assembly 136 (shown in FIG. 3), and in the example, the cavities 202 are defined in the outer surface 204. In addition to increasing the surface area of the pivoting arm 200 for heat dissipation, the cavities 202 can alter the magnetic field of the conductor so that lighter braking resistance is induced when the pivoting arm 200 first enters into the magnets. This increases the dynamic range (e.g., variable resistance) of the braking mechanism 130 as required or desired. In other examples, the cavities 202 may additionally or alternatively be formed on a side surface 206 of the pivoting arm 200 and/or an end surface 208 of the pivoting arm 200. In other examples, the outer surface 204 may be modified to be shaped more like a blade (e.g., with a pressure sidewall and a suction sidewall) so as to increase cooling air flow into the braking mechanism 130 and/or increase exhaustion of warm air flow out of the braking mechanism 130.

FIG. 4B is a perspective view of another pivoting arm 250 for a braking mechanism 130 (shown in FIG. 2). In this example, the pivoting arm 250 may include one or more slots 252 that increase the surface area of the pivoting arm 250 to increase heat dissipation during operation. Additionally, the slots 252 may function as fan blades that increase cooling air flow into the braking mechanism 130 and/or increase exhaustion of warm air flow out of the braking mechanism 130. That is, the slots 252 may be oriented so as to channel air flow out of the interior area of the rotor assembly and/or oriented so as to channel air flow into the interior area of the rotor assembly. In the example, the slots 252 are formed in one or both of a side surface 254 of the pivoting arm 250. The slots 252 may extend substantially radially towards an outer surface 256 of the pivoting arm 250. In other examples, the slots 252 may be oriented in any other direction that enables function of the pivoting arm 250 as described herein (e.g., extending substantially circumferentially within the pivoting arm 250). Additionally or alternatively, the slots may be formed on an outer surface 256 and/or end surfaces 258.

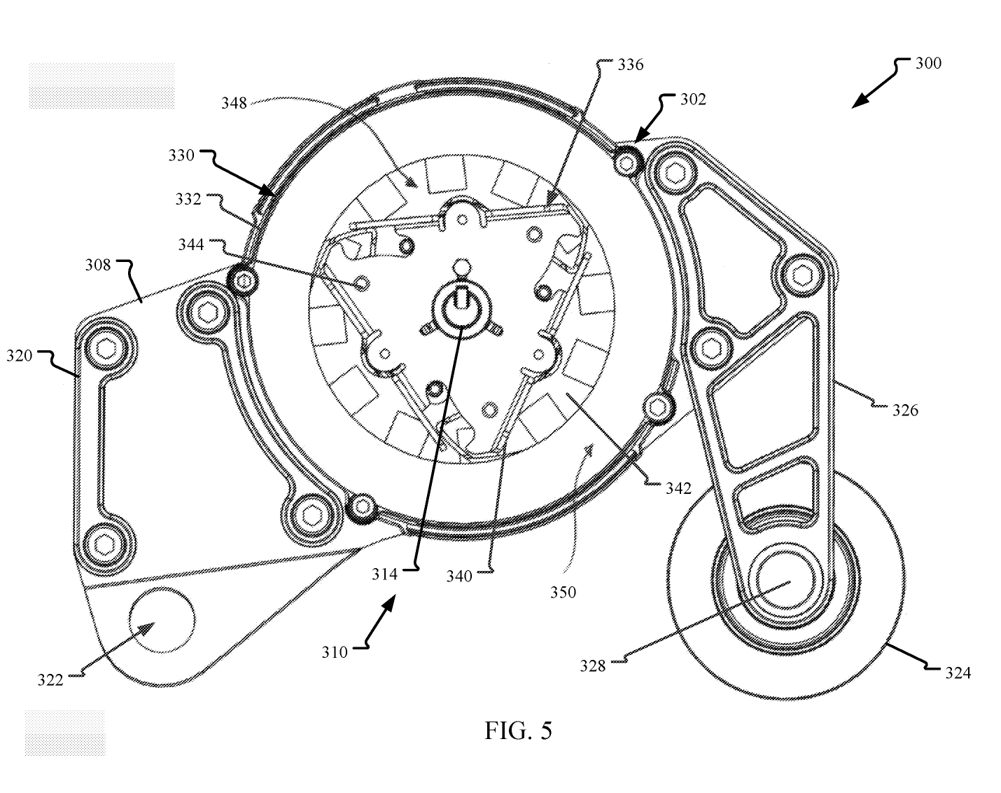

FIG. 5 is a side view of another trolley 300. Similar to the trolley described above, the trolley 300 includes a housing 302 that rotatably supports a drive sheave 304 (not shown) at least partially therein. The housing 302 may be formed by a pair of opposing side plates 306 (not shown), 308 with the drive sheave 304 disposed between. A bottom opening 310 is formed so that the trolley 300 can be installed on and removed from a cable. The drive sheave 304 is coupled to a drive sheave axle 314 such that rotation of the drive sheave 304 drives corresponding rotation of the drive sheave axle 314. On the front portion of the trolley 300, a bumper 320 extends from one or more of the side plates 306, 308. Additionally, on the front portion of the trolley 300, an anchor point 322 is defined on one or more of the side plates 306, 308. Opposite of the bumper 320 and the anchor point 322, and on the rear portion of the trolley 300, an opposition sheave 324 extends below the housing 302. An arm 326 extends from one or more of the side plates 306, 308 and rotatably supports the opposition sheave 324 about an axle 328. Coupled to one side of the housing 302 (e.g., the side plate 308) is an eddy current braking mechanism 330. In the example, the braking mechanism 330 includes a housing 332 (illustrated as partially removed in FIG. 5) that houses a rotor assembly 336. In this example, however, the rotor assembly 336 includes one or more magnets 348 coupled thereto and a conductor 350 is disposed around an outer perimeter of the rotor assembly 336. In some examples, by coupling the magnets 348 to the rotor assembly 336 the housings 332 and/or 302 may be used as the conductive element instead of having a separate component.

The braking mechanism 330 is a centrifugal type eddy current brake system disposed within the housing 332 and is at least partially coupled to the drive sheave axle 314. More specifically, the rotor assembly 336 includes a rotor 340 that is coupled to the drive sheave axle 314. One or more pivoting arms 342 are coupled to the rotor 340 at a pivot point 344 and biased by a spring (not shown). In this example, the pivoting arms 342 include magnets 348 that are configured to be radially disposed outward therefrom. Additionally, the braking mechanism 330 includes one or more conductors 350 supported by the housing 332. In the example, the conductors 350 are on both sides of the rotor assembly 336. However, in other examples, the conductors 350 may be positioned only on one side of the rotor assembly 336 as required or desired (e.g., for space and/or cost considerations). In still other examples, the trolley housing 302 and/or the braking mechanism housing 332 may act as the conductor as required or desired.

FIG. 6 is a perspective view of another trolley 400 with a portion of a housing 402 removed for clarity. The trolley 400, similar to the trolleys described above, is configured to engage with a cable 404 and traverse along the cable 404 in a forward direction D. In this example, the housing 402 rotatably supports a first forward sheave 406 and a second rearward sheave 408 that are positioned above the cable 404 when the trolley 400 is installed therein. The first sheave 406 may be the drive sheave and supported by a drive sheave axle 410. The first sheave 406 is coupled to an eddy current braking mechanism 412 that is at least partially disposed within the housing 402. The second sheave 408 may be a non-drive sheave and supported by a non-drive sheave axle 414. The braking mechanism 412 includes a rotor assembly 416 supported on a braking axle 418. The braking axle 418 is parallel to but offset from the drive sheave axle 410, and as such, a transmission 420 is used to couple the braking axle 418 to the drive sheave axle 410.

In the example, the braking mechanism 412 is configured to generate an eddy current braking force and includes one or more stationary magnets 422 circumferentially surrounding the rotor assembly 416, while the rotor assembly 416 includes one or more conductors 424 that are configured to radially extend from a rotor 426 during rotation of the braking axle 418. It is appreciated that in other embodiments, the conductor 424 may be stationary supported on the housing 402, while the magnets 422 are coupled to the rotor 426 as required or desired. Since the braking axle 418 is coupled to the drive sheave axle 410 by the transmission 420, the transmission 420 can increase or decrease the rotational speed of the braking axle 418 relative to the rotational speed drive sheave 406. For example, the transmission 420 enables the rpm of the drive sheave axle 410 to be increased by a drive ratio of 2 (e.g., 1:2). In other examples, the rpm of the drive sheave axle 410 may be decrease by a drive ratio of 2 (e.g., 2:1). In still other examples, any other ratio as required or desired may be implemented, including a 1:1 ratio so that the transmission 420 enables for remote placement of the braking mechanism 412 on the housing 402. This control of the braking mechanism 412 further increases speed control of the trolley 400 and increases the performance thereof. In the example, the transmission 420 is formed from a plurality of spur gears. However, any other transmission system (e.g., chain, belt, screw, etc.) may be used as required or desired.

In operation, the trolley 400 supports a load that can be distributed equally or non-equally between the first and second sheaves 406, 408. When the trolley 400 is loaded, the sheaves 406, 408 are frictionally engaged with the cable 404 so that the sheave 406 coupled to the braking mechanism 412 is reduced or prevented from slipping on the cable 404 when a braking force is applied. In the example, the braking mechanism 412 is coupled to the first sheave 406 via the transmission 420. In other examples, the braking mechanism 412 may be coupled to the second sheave 408, or to both sheaves 406, 408 as required or desired. Additionally or alternatively, the sheaves 406, 408 may be at least partially formed from a resilient elastomer material so as to increase the friction between the sheaves 406, 408 and the cable 404. In one example, the portion of the sheaves 406, 408 that contact the cable 404 can be formed from a polyurethane material. In another example, the portion of the sheaves 406, 408 that contact the cable 404 may be textured (e.g., surface features or preparations) to augment traction thereof.

Additionally or alternatively, other trolley 400 configurations may be used so as to increase drive sheave 406 frictional engagement with the cable 404. In one example, two or more sheaves may be placed above the cable and one or more opposition sheaves may be placed below the cable. In another example, one or more sheaves may be tensioned against opposing sheaves by a tensioning mechanism, such as a threaded tensioner, a spring-loaded tensioner, and/or a quick-release tensioner. In still another example, the drive sheave 406 may be one or more sheaves, positioned either above or below the cable.

By using the transmission 420 to couple rotational movement between the drive sheave axle 410 and the braking axle 418, the braking mechanism 412 may be supported anywhere on the trolley 400. As illustrated, the transmission 420 and the braking mechanism 412 may be disposed at least partially within the housing 402, for example, to decrease user access thereto. In other examples, the transmission 420 and/or braking mechanism 412 may be disposed outside of the housing 402, for example, to increase coolant air flow thereto.

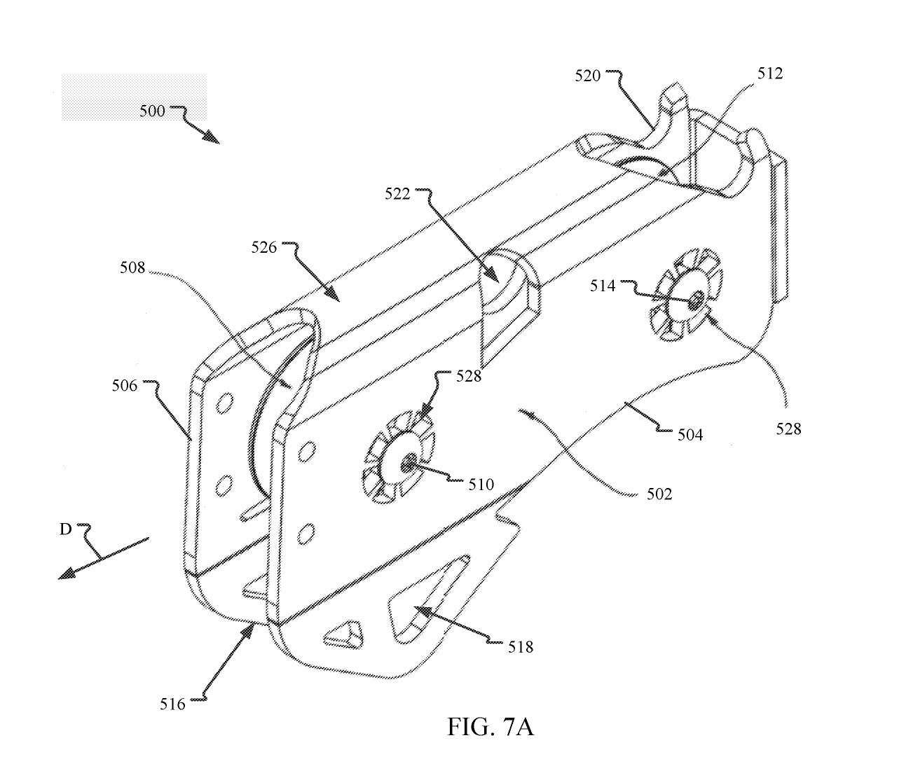

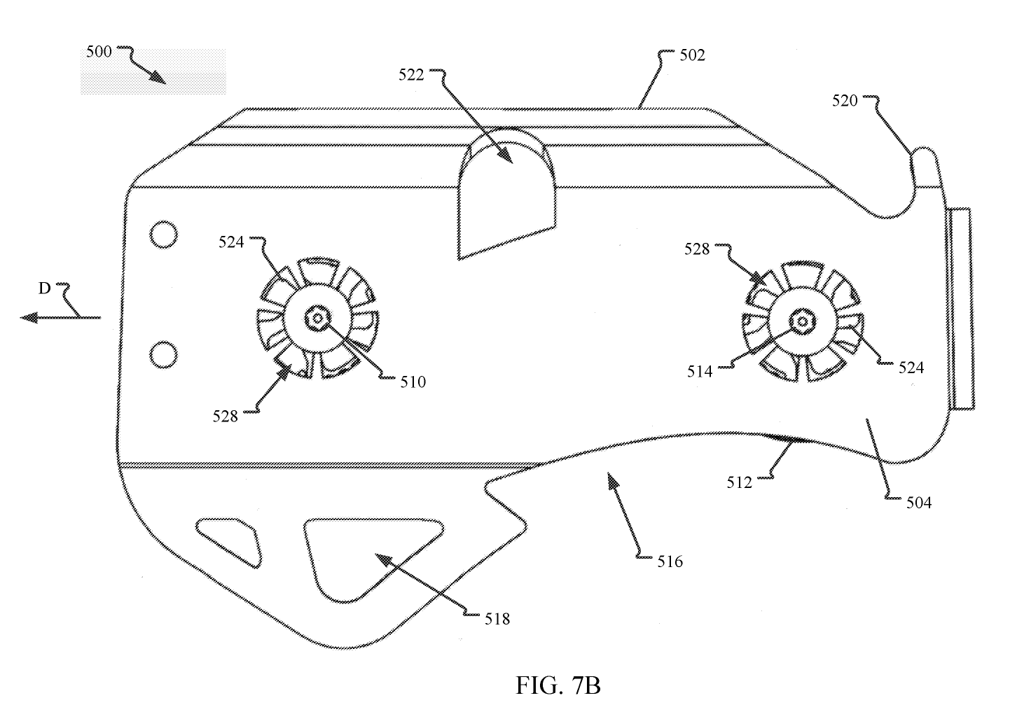

FIG. 7A is a perspective view of another trolley 500. FIG. 7B is a side view of the trolley 500. Referring concurrently to FIGS. 7A and 7B, the trolley 500, similar to the trolleys described above, is configured to engage with a cable (not shown) and traverse along the cable in a forward direction D. In this example, the trolley 500 includes a housing 502 having two opposing side plates 504, 506. A first forward sheave 508 is disposed between the side plates 504, 506 and rotatably supported by a first axle 510. Additionally, a second rearward sheave 512 is disposed between the side plates 504, 506 and rotatably supported by a second axle 514. The housing 502 defines a bottom opening 516 so that the trolley 500 can be installed on a cable with the sheaves 508, 512 positioned on top of the cable. The housing 502 may also include an anchor point 518 on a bottom portion of the trolley 500, a hook 520 on a top portion of the trolley 500, and/or an aperture 522 also on a top portion of the trolley 500. The structure of the housing 502 is similar to that disclosed in U.S. Patent Application Publication 2015/0266454 to McGowan, published Sep. 24, 2015, entitled “CABLE-TRAVERSING TROLLEY ADAPTED FOR USE WITH IMPACT BRAKING,” and which is hereby incorporated by reference in its entirety.

In this example, the trolley 500 also includes an eddy current braking mechanism, however, the braking mechanism is formed between the sheaves 508, 512 and the housing 502. More specifically, magnets 524 (shown in FIG. 7B) are coupled to the sheaves 508, 512 and the housing 502 itself is used as the conductor 526. For example, the housing 502 may be formed from an aluminum-based material, or any other conductive material as required or desired. As such and similar to the example described above in FIG. 5, when the speed of the trolley 500 along the cable increases, the sheaves 508, 512 rotate with increased speed and the magnets 524 are radially displaced and over-lap with the conductor 526, thereby generating an eddy current braking force that is speed dependent. This centrifugal eddy current braking mechanism is described in greater detail in U.S. Pat. No. 8,851,235 to Allington et al., granted Oct. 7, 2014, entitled “BRAKING MECHANISMS,” and which is hereby incorporated by reference in its entirety.

One or more vent openings 528 may be formed in the housing 502 proximate each sheave 508, 512. The vent openings 528 facilitate channeling air into the housing 502 so as to cool the sheaves 508, 512 during operation. Additionally, since the housing 502 operates as the conductor 526, the vent openings 528 decrease the magnetic field of the conductor 526, and thus, reduces eddy current braking when the magnets 524 are in their radially retracted position. As such, when the sheaves 508, 512 are slowly rotating, the magnets 524 are retracted towards the center of the sheaves 508, 512 and aligned with the vent openings 528 reducing the eddy current braking force. Upon an increase in the rotational speed of the sheaves 508, 512, the magnets extend radially outwards from the center of the sheaves 508, 512 and overlap with the conductor 526 (e.g., the housing 502) increasing the eddy current braking force and slowing the speed of the trolley 500 along the cable. In other examples, the housing 502 may include low-conductivity or non-conductive inserts that at least partially surround the axles 510, 514. In yet other examples, a low-conductivity or non-conductive housing 502 may be used with conductive inserts that at least partially surround the axles 510, 514. In still other examples, multi-part housing construction may be used, with predetermined housing areas of high-conductivity and low-conductivity. By using the housing 502 as the conductor 526, the number of components within the trolley 500 is reduced, thereby increasing performance (e.g., manufacturing and wear efficiencies) thereof.

In operation, the trolley 500 is installed on the cable such that the sheaves 508, 512 are positioned on top of the cable. As such, the sheaves 508, 512 are frictionally engaged with the cable. The dynamic eddy current brake mechanism in the trolley 500 may be used to generally scrub speed during operation. Additionally or alternatively, other trolley 500 configurations may be used so as to increase sheave 508, 512 frictional engagement with the cable. In one example, two or more sheaves may be placed above the cable and one or more opposition sheaves may be placed below the cable. In another example, one or more sheaves may be tensioned against opposing sheaves by a tensioning mechanism, such as a threaded tensioner, a spring-loaded tensioner, and/or a quick-release tensioner. In still another example, the trolley 500 may have larger diameter sheaves so as to increase the eddy current braking force generated as required or desired.

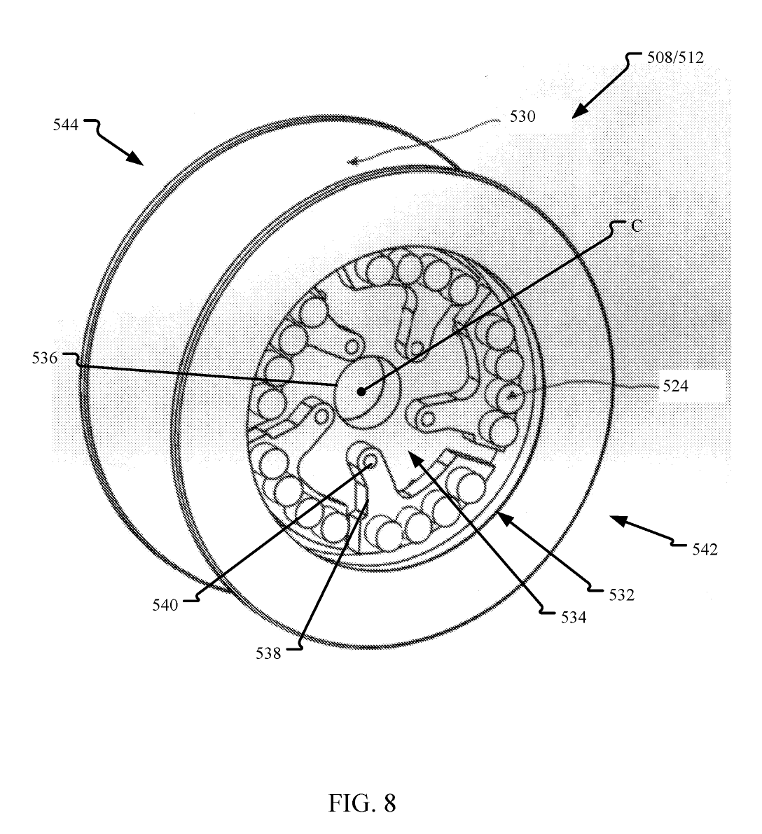

FIG. 8 is a perspective view of the sheave 508, 512 of the trolley 500 (shown in FIGS. 7A and 7B). The sheave 508, 512 includes an outer annular surface 530 that is configured to engage with the cable and a hub 532 that couples to the axle 510, 512 (shown in FIGS. 7A and 7B). Coupled to the hub 532 is a rotor assembly 534 disposed at least partially within the outer annular surface 530. The rotor assembly 534 includes a rotor 536 and one or more pivoting arms 538 coupled to the rotor 536 at a pivot point 540 with biasing springs (not shown) disposed behind the rotor 536. In this example, the magnets 524 are mounted on the pivoting arms 538 and the rotor assembly 534 is configured to provide a centrifugal force based eddy current braking mechanism as described herein. In the example, the rotor assembly 534 is fully disposed with the sheave 508, 512 and there is a rotor assembly 534 on each side 542, 544 of the sheave 508, 512. In other examples, only one side 542 or 544 may include the rotor assembly 534. In still other examples, at least a portion of the rotor assembly 534 may be disposed at least partially external to the sheave 508, 512, for example, the rotor 536 coupled to a sidewall of the sheave or the pivoting arms 538 are disposed adjacent to the sidewall of the sheave.

Additionally, as illustrated, there are five pivoting arms 538 circumferentially spaced about the rotor 536. Each arm 538 includes four round magnets 524. However, it is appreciated that many other configurations may also be used. For example, there can be a greater or fewer number of pivoting arms 538, the pivoting arms 538 may be of a different size and/or shape, there can be a greater or fewer number of magnets 524, and/or the magnets 524 may be of a different size and/or shape.

In operation, when the sheave 508, 512 is slowly rotating or not rotating at all, the pivoting arms 538 are biased by the springs in a retracted position toward a center C of the hub 532. This configuration is illustrated in FIG. 8 and in this configuration, the magnets 524 are positioned as to reduce or eliminate overlap with the conductive material of, or attached to, the trolley housing. As such, eddy current braking forces on the sheave 508, 512 are reduced or eliminated. However, as rotational velocity of the sheave 508, 512 increases, the pivoting arms 538 radially extend due to centrifugal force and overlap more with the conductive material of the trolley, thereby increasing the eddy current braking force and reducing the speed of the trolley as it traverses along the cable.

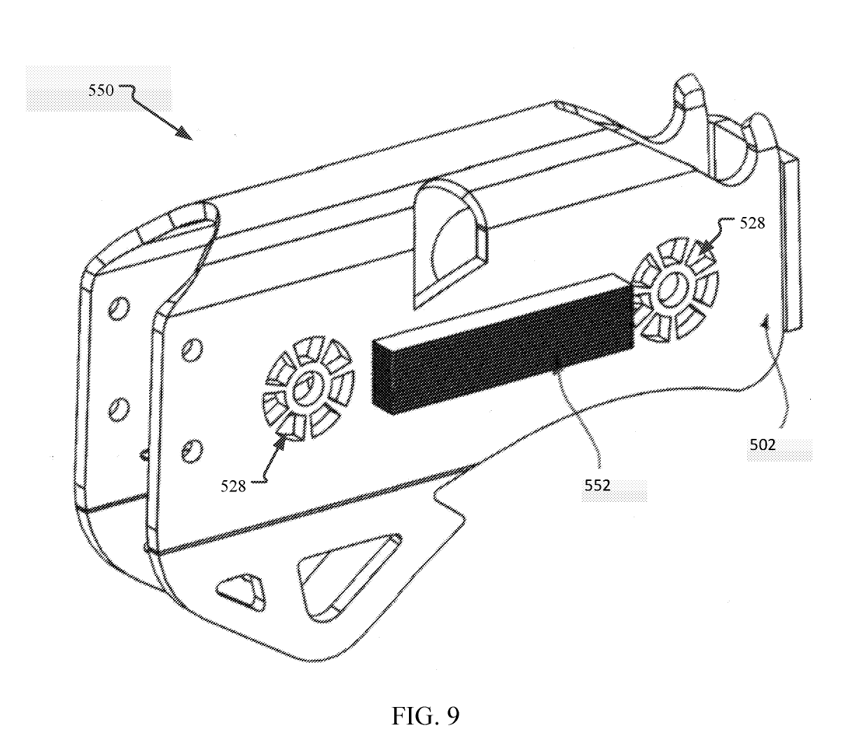

FIG. 9 is a perspective view of another trolley 550. Similar to the trolley 500 (shown in FIGS. 7A-8), the trolley 550 includes the housing 502 that is configured to rotatably support one or more sheaves 508, 512 with an eddy current rotor assembly 534 coupled thereto (both shown in FIG. 8). In operation and described above, the trolley 500 may increase in temperature, and as such, the performance of the trolley 550 can be undesirably affected (e.g., reduced braking efficiencies). In one example, vent openings 528 can be formed proximate the sheaves 508, 512 to increase coolant air flow within the housing 502. Additionally or alternatively, to dissipate heat within the trolley 550, a heat sink 552 may be coupled to one or more of the trolley components. In the example, the heat sink 552 may be coupled to the housing 502 so that the surface area of the housing 502 is increased and dissipates heat more quickly. In other examples, portions of the housing 502 may be milled, formed, or molded with integral heat sink fins so as to increase the surface area of the housing 502. In still other examples, the heat sink 552 may be coupled or formed on any other component of the trolley 550 as required or desired.

It is appreciated that the heat sinks 552 and the vent openings 528 are not the only cooling methods that can be used with the trolley 550. Thermal resistant coatings may be applied to trolley surfaces as required or desired. In other examples, fan blades may be coupled to rotating and/or static components (e.g., as stator vanes) to enable air flow to be channeled to trolley components as required or desired. One example of using blades to cool an eddy current braking trolley is described in U.S. Pat. No. 8,601,951 to Lerner, granted Dec. 10, 2013, entitled “SELF-COOLING TROLLEY,” and which is hereby incorporated by reference in its entirety. In still other examples, active or passive heat transfer system may be used as required or desired (e.g., heat pumps, heat pipes, thermoelectric coolers, and/or other like heat exchangers).

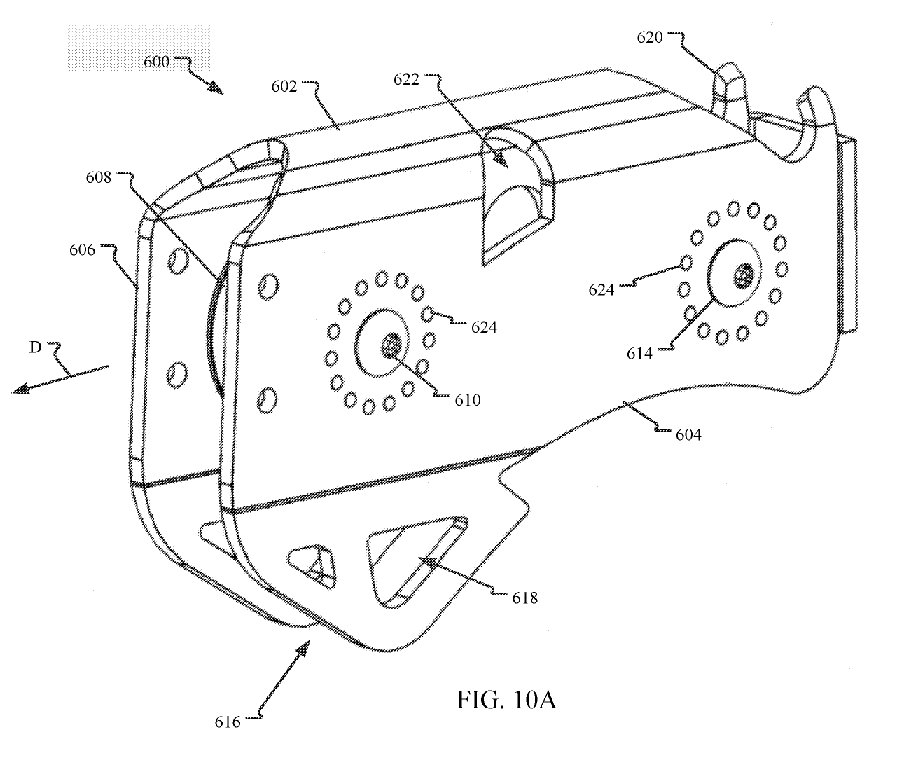

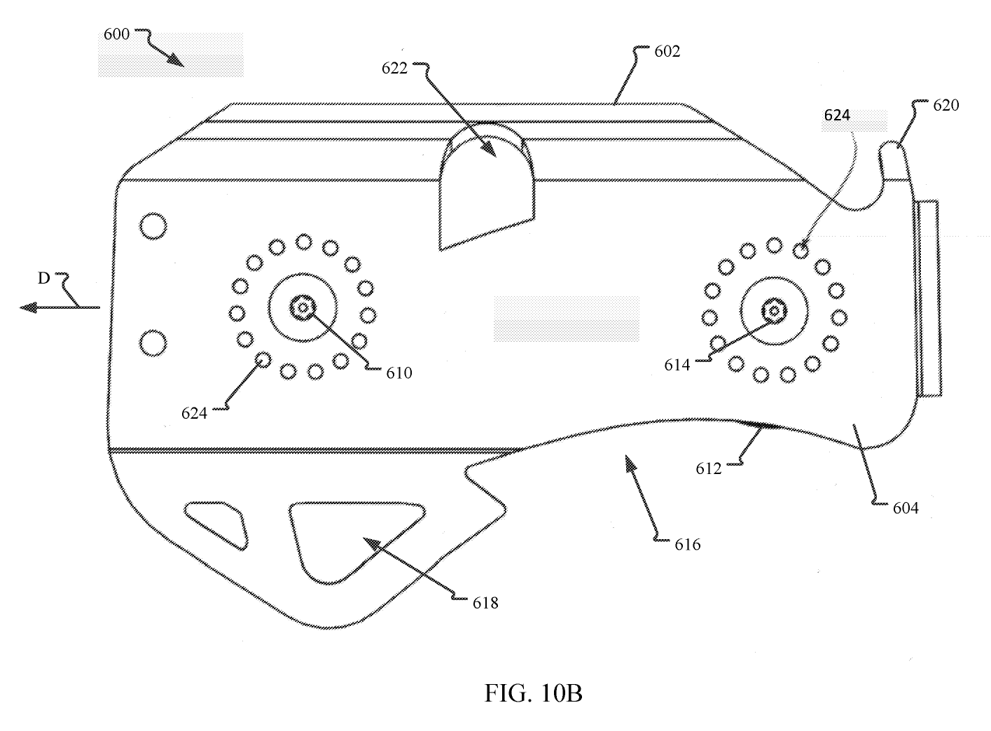

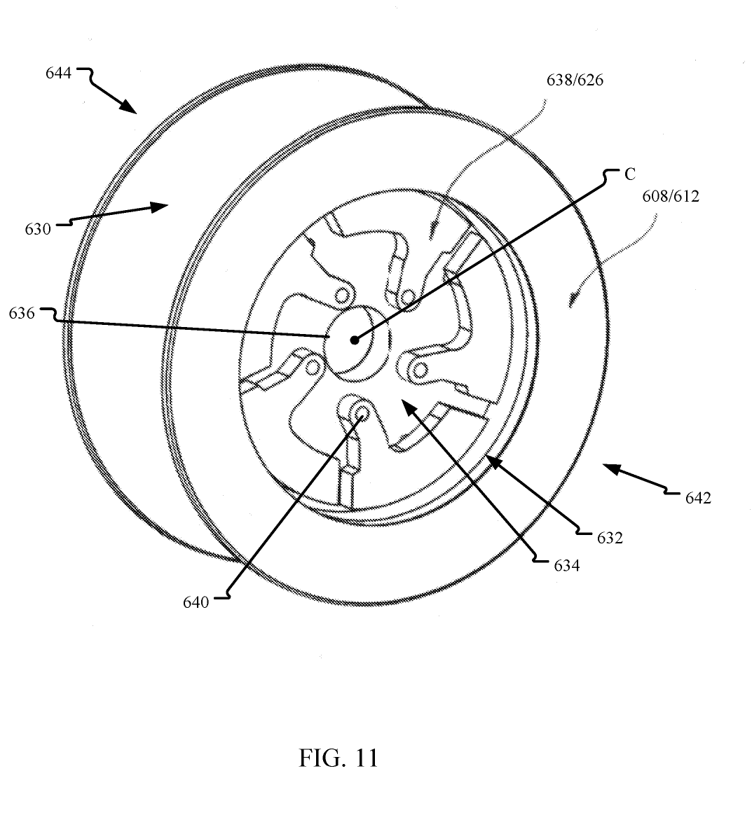

FIG. 10A is a perspective view of another trolley 600. FIG. 10B is a side view of the trolley 600. Referring concurrently to FIGS. 10A and 10B, the trolley 600, similar to trolley 500 (shown in FIGS. 7A-8) and described above, is configured to engage with a cable (not shown) and traverse along the cable in a forward direction D. In the example, the trolley 600 includes a housing 602 having two opposing side plates 604, 606. A first forward sheave 608 is disposed between the side plates 604, 606 and rotatably supported by a first axle 610. Additionally, a second rearward sheave 612 (shown in FIG. 11B) is disposed between the side plates 604, 606 and rotatably supported by a second axle 614. The housing 602 defines a bottom opening 616 so that the trolley 600 can be installed on a cable with the sheaves 608, 612 positioned on top of the cable. The housing 602 may also include an anchor point 618 on a bottom portion of the trolley 600, a hook 620 on a top portion of the trolley 600, and/or an aperture 622 also on a top portion of the trolley 600. The structure of the housing 602 is similar to that disclosed in U.S. Patent Application Publication 2015/0266454 to McGowan, published Sep. 24, 2015, entitled “CABLE-TRAVERSING TROLLEY ADAPTED FOR USE WITH IMPACT BRAKING,” and which is hereby incorporated by reference in its entirety.

In this example, the trolley 600 also includes an eddy current braking mechanism, however, the braking mechanism is formed between the sheaves 608, 612 and the housing 602. More specifically, magnets 624 are mounted to the housing 602 and the sheaves 608, 612 include a conductor 626 (shown in FIG. 11). For example, the housing 602 may include a circular array of magnets 624 at least partially surrounding the axles 610, 614. As such and similar to the example described above in FIGS. 2 and 3, when the speed of the trolley 600 along the cable increases, the sheaves 608, 612 rotate with increased speed and the conductors 626 are radially displaced and over-lap with the magnets 524 supported by the housing 602, thereby generating an eddy current braking force that is speed dependent. This centrifugal eddy current braking mechanism is described in greater detail in U.S. Pat. No. 8,851,235 to Allington et al., granted Oct. 7, 2014, entitled “BRAKING MECHANISMS,” and which is hereby incorporated by reference in its entirety.

In some examples, more than one circumferential ring of magnets 624 may be supported by the housing 602 so that the magnetic field increases radially outwardly from the axles 610, 614. As such, when the sheaves 608, 612 are slowly rotating, the conductors 626 are retracted towards the center of the sheaves 608, 612 and reducing the eddy current braking force applied. Upon an increase in the rotational speed of the sheaves 608, 612, the conductors 626 extend radially outwards from the center of the sheaves 608, 612 and overlap the magnets 624 increasing the eddy current braking force and slowing the speed of the trolley 600 along the cable. In other examples, magnets 624 may be sized and/or shaped to vary the magnetic field strength. Examples of magnet arrays and shapes are described in U.S. Patent Application Publication No. 2016/0052401 to McGowan et al., published Feb. 25, 2016, entitled “EDDY CURRENT BRAKING DEVICE FOR ROTARY SYSTEMS,” and which is hereby incorporated by reference in its entirety.

In operation, the trolley 600 is installed on the cable such that the sheaves 608, 612 are positioned on top of the cable. As such, the sheaves 608, 612 are frictionally engaged with the cable. The dynamic eddy current brake mechanism in the trolley 600 may be used to generally reduce speed during operation. Additionally or alternatively, other trolley 600 configurations may be used so as to increase sheave 608, 612 frictional engagement with the cable. In one example, two or more sheaves may be placed above the cable and one or more opposition sheaves may be placed below the cable. In another example, one or more sheaves may be tensioned against opposing sheaves by a tensioning mechanism, such as a threaded tensioner, a spring-loaded tensioner, and/or a quick-release tensioner. In still another example, the trolley 600 may have larger diameter sheaves so as to increase the eddy current braking force generated as required or desired.

FIG. 11 is a perspective view of the sheave 608, 612 of the trolley 600 (shown in FIGS. 10A and 10B). The sheave 608, 612 includes an outer annular surface 630 that is configured to engage with the cable and a hub 632 that couples to the axle 610, 614 (shown in FIGS. 11A and 11B). Coupled to the hub 632 is a rotor assembly 634 disposed at least partially within the outer annular surface 630. The rotor assembly 634 includes a rotor 636 and one or more pivoting arms 638 coupled to the rotor 636 at a pivot point 640 with biasing springs (not shown) disposed behind the rotor 636. In this example, the pivoting arms 638 are the conductors 626 and the rotor assembly 634 is configured to provide a centrifugal force based eddy current braking mechanism as described herein. In the example, the rotor assembly 634 is fully disposed with the sheave 608, 612 and there is a rotor assembly 634 on each side 642, 644 of the sheave 608, 612. In other examples, only one side 642 or 644 may include the rotor assembly 634. In still other examples, at least a portion of the rotor assembly 634 may be disposed at least partially external to the sheave 608, 612, for example, the rotor 636 coupled to a sidewall of the sheave or the pivoting arms 638 are disposed adjacent to the sidewall of the sheave.

Additionally, as illustrated, there are five pivoting arms 638 circumferentially spaced about the rotor 636. However, it is appreciated that many other configurations may also be used. For example, there can be a greater or fewer number of pivoting arms 638 and/or the pivoting arms 638 may be of a different size and/or shape.

In operation, when the sheave 608, 612 is slowly rotating or not rotating at all, the pivoting arms 638 are biased by the springs in a retracted position toward a center C of the hub 632. This configuration is illustrated in FIG. 11 and in this configuration, the conductors 626 are positioned as to reduce or eliminate overlap with the magnets attached to the trolley housing. As such, eddy current braking forces on the sheave 608, 612 are reduced or eliminated. However, as rotational velocity of the sheave 608, 612 increases, the pivoting arms 638 radially extend due to centrifugal force and overlap more with the magnetic material of the trolley, thereby increasing the eddy current braking force and reducing the speed of the trolley as it traverses along the cable.

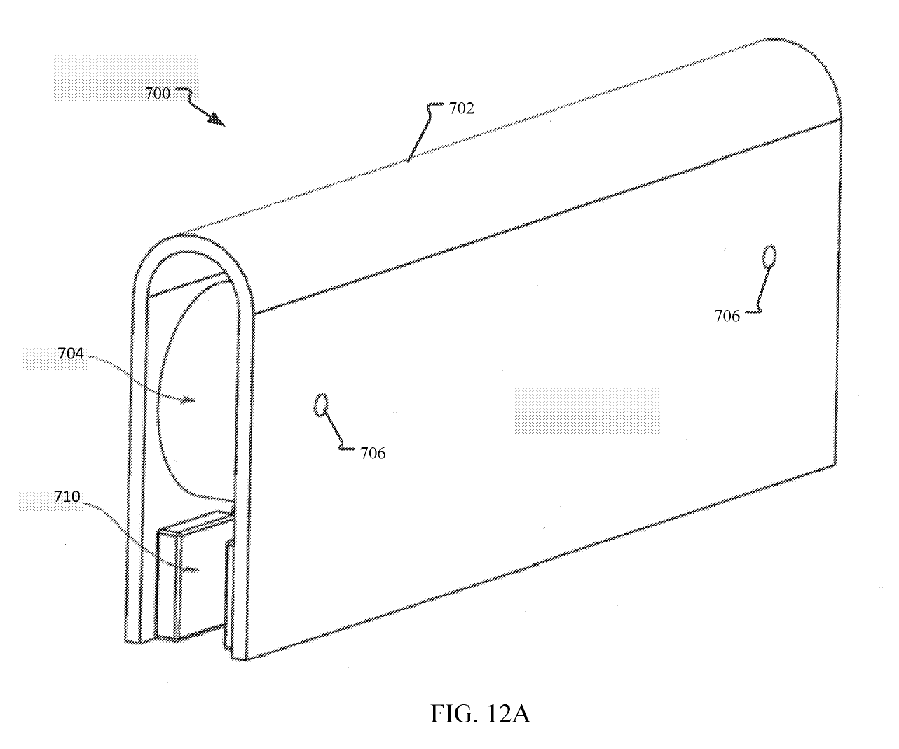

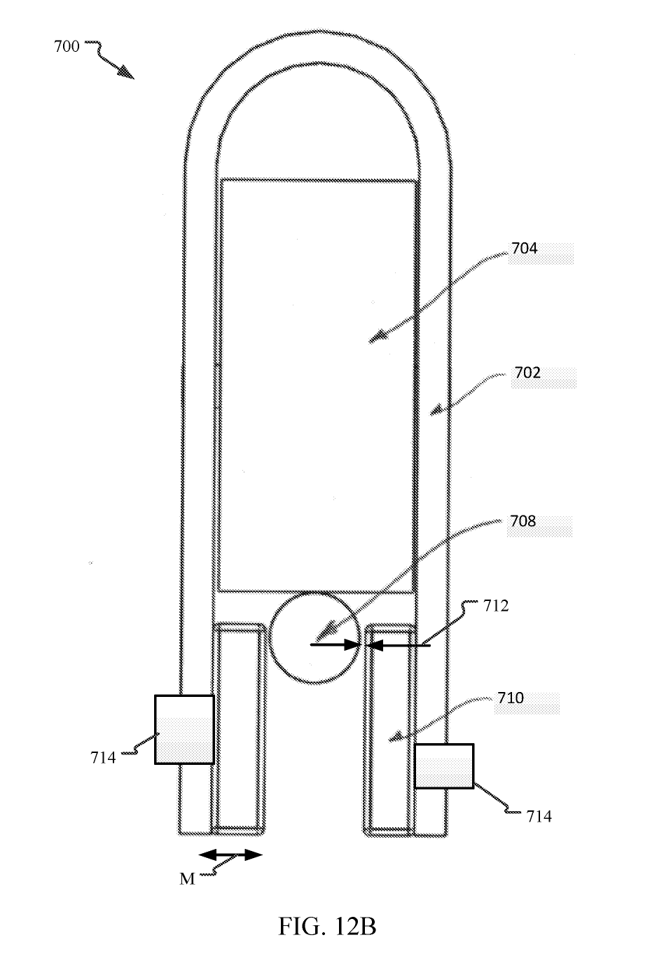

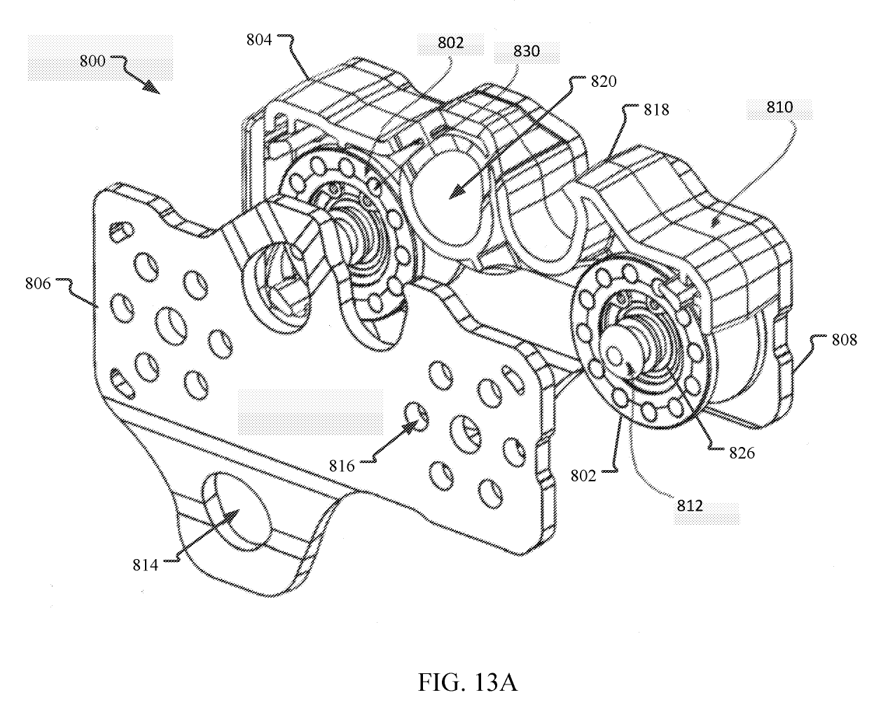

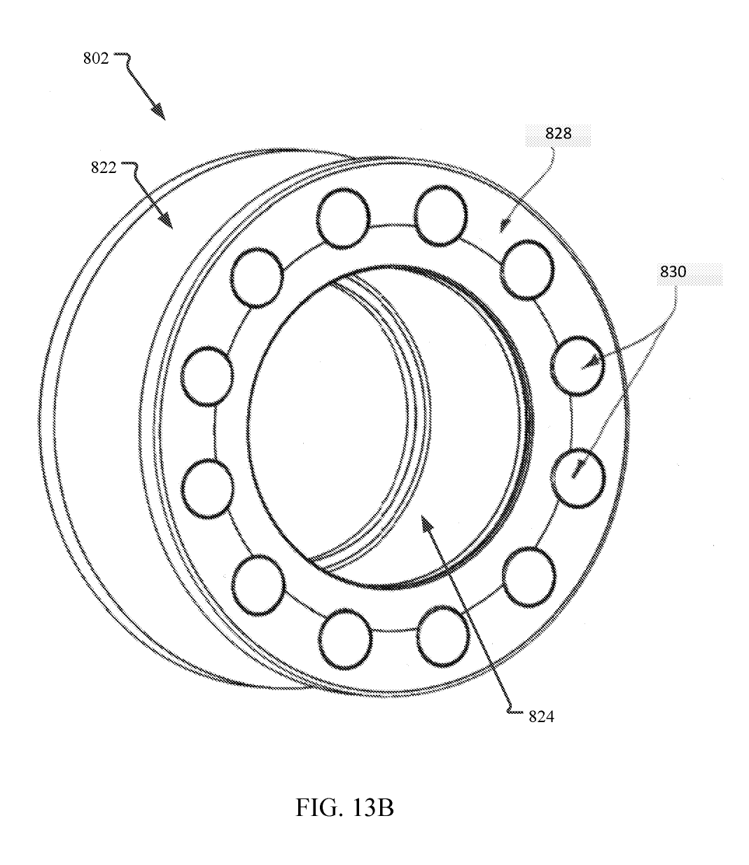

In the examples described above and illustrated in FIGS. 1-11, the trolley includes a centrifugal eddy current braking mechanism that provides variable braking resistance. That is, the braking resistance is at least partially based on the rotational speed of the rotor assembly. This enables the trolley to function similarly along the cable with both heavier loads and lighter loads. In other examples, it may be desirable to have the trolley generate the same braking resistance no matter the weight attached. For example, undesirable weather conditions (e.g., a tailwind) may require a reduction in trolley speed across all load weights. In another example, predetermined curves and/or slopes in the cable may require a reduction in trolley speed across all load weights. Accordingly, the trolleys described below and illustrated in FIGS. 12A-13B all include a “fixed” eddy current braking mechanism that provides a non-variable braking resistance. In some of these examples, the trolley includes one component (e.g., magnet or conductor) of the braking mechanism and the cable or structure that the trolley traverses along includes the other component (e.g., conductor or magnet). Some examples of a trolley interacting with a cable or structure to produce an eddy current braking force are described in U.S. Patent Application Publication No. 2016/0052400 to McGowan et al., published Feb. 25, 2016, entitled “EDDY CURRENT BRAKING DEVICE FOR LINEAR SYSTEMS,” and which is hereby incorporated by reference in its entirety. In other examples, the trolley may include both magnet and conductor components.

FIG. 12A is a perspective view of another trolley 700. FIG. 12B is a front view of the trolley 700. Referring concurrently to FIGS. 12A and 12B, the trolley 700 includes a housing 702 with one or more sheaves 704 rotatably mounted at least partially therein. In this example, the trolley 700 has two sheaves 704, each rotatably mounted on an axle 706 so that the trolley 700 may traverse along a cable 708. The trolley 700 also includes one or more magnets 710 that form part of an eddy current braking mechanism. In the example, when the trolley 700 is installed on the cable 708, the sheaves 704 are mounted on top of the cable 708. Additionally, at least a portion of the housing 702 extends below the cable 708 so that the magnets 710 may be positioned proximate the cable 708 and inside of the housing 702. In other examples, the magnets 710 may be attached to any other fixed component of the trolley 700 as required or desired such that the magnets 710 maintain their proximity to the cable 708. In still other examples, the magnets 710 may be coupled to a trailing device (not shown) that is attached to the trolley 700 and follows the movement of the trolley 700 along the cable 708. This trailing device enables for existing trolleys (e.g., without eddy current braking mechanism) to still be used in cable and structure systems.

In operation, the cable 708 acts as the conductor and as the trolley 700 carrying the magnets 710 travels along the cable 708, a constant (e.g., fixed) eddy current resistance is generated and a braking force is induced on the trolley 700. Typically, ferrous cables 708 (e.g., steel cables) are less efficient than non-ferrous conductors for eddy current braking, but even a small amount of braking force can slow the trolley 700 a couple of kilometers per hour while traversing along the cable 708. For example, if a tailwind is present or before a curve in the cable. If a greater amount of braking force on the trolley 700 is required or desired, then the cable 708 or other structure may be formed from highly conductive non-ferrous materials (e.g., aluminum) so that a greater amount of eddy current resistance is generated. In other examples, separate conductive structures (e.g., fins, coverings, etc.) may be coupled to the cable 708 so as to provide conductive elements on the cable 708. In still other examples, the cable 708 may be a ferrous or non-ferrous rail or structural member that the trolley 700 traverses. In yet other examples, the cable 708 may include the magnetic element while the trolley 700 includes the conductive element, for example, the housing 702.

In the example, the magnets 710 of the trolley 700 may be disposed on two sides of the cable 708 as illustrated in FIG. 12B. However, the magnets 710 may also be disposed only on one side of the cable 708 as required or desired. The magnets 710 are separated from the cable 708 by an eddy current gap 712 so that the magnets 710 do not make contact with the cable 708. Additionally, the distance of the gap 712 at least partially determines the resistance force of the eddy current braking mechanism. Generally, the smaller the gap 712 the greater amount of braking force when compared to larger gap distances. In some examples, the distance of the gap 712 may be adjustable prior to use by an adjustment device 714 (e.g., a linkage or threaded member). The adjustment device 714 enables the magnets 710 to selectively move M towards or away from the cable 708. However, when the trolley 700 is in operation the gap 712 remains constant so that the resistance force generated is constant. In other examples, an operator (not shown) may be used and that receives a series of spacers of different thickness to place between the housing 702 and the magnets 710. These adjustment mechanisms enable the operator of the trolley 700 to tune the braking characteristics of the trolley 700 after construction thereof.

FIG. 13A is an exploded perspective view of another trolley 800. FIG. 13B is a perspective view of a sheave 802 of the trolley 800. Referring concurrently to FIGS. 13A and 13B, the trolley 800 includes an eddy current braking mechanism that generates a constant (e.g., fixed) braking force as described above. In this example, however, the braking mechanism is completely contained within the trolley 800. The trolley 800 includes a housing 804 having two side plates 806, 808 and a spacer 810 therebetween. Also between the side plates 806, 808 are two sheaves 802, each rotatably mounted about a fixed axle 812. When the trolley 800 is installed on the cable (not shown), the sheaves 802 are mounted on top of the cable and an anchor point 814 may be disposed below the cable. The side plates 806, 808 may include one or more vent openings 816 disposed proximate the sheaves 802 to provide cooling. Additionally, the housing 804 may include a hook 818 and/or an aperture 820 both along a top portion of the housing 804.

The sheave 802 includes an outer annular surface 822 that is configured to engage with the cable and a hub cavity 824 that receives a bearing 826 so that the sheave 802 can couple to the axle 812. Sidewalls 828 extend between the outer surface 822 and the hub cavity 824 and include one or more magnets 830 disposed at least partially therein. For example, the sidewalls 828 may have cavities in which the magnets 830 are placed. In other examples, the magnets 830 may be formed within the material of the sheave 802 itself. In the example, the magnets 830 are circumferentially spaced around the sheave 802, although other arrays may be used as required or desired. In operation, the side plates 806, 808 are formed from an aluminum-based material and act as the conductor for the braking mechanism. The magnets 830 rotate with sheave 802 while the trolley 800 is traversing along the cable. Since the conductor is at a fixed distance away from the magnets 830, the eddy current braking mechanism generates a constant resistance braking force on the trolley 800. In some examples, the thickness of the spacer 810 may be used to set the gap between the magnets 830 and the side plates 806, 808. In other examples, the distance that the magnets 830 are recessed within the sidewalls 828 may be used to set the gap between the magnets 830 and the side plates 806, 808. In yet other examples, only some of the cavities in the sidewalls 828 are filled with magnets 830 and/or some magnets 830 have different magnetic strengths so as to be able to adjust the resistance strength of the generated eddy current. In still other examples, some cavities may include a depth within the sidewalls 828 that are greater than the depth of others so that the gap between the magnets 830 and the side plates 806, 808 can be adjusted or vary as required or desired.

In this example, by using the housing 804 as the conductor, the number of components of the trolley 800 is reduced, thereby increasing durability and manufacturing efficiencies. In other examples, separate conductive elements may be coupled to the housing 804 proximate the sheaves 802 as required or desired. Additionally, the trolley 800 may have any number, size, or shape of sheaves 802, magnets 830, vent openings 816, spacers 810, etc. that enable the eddy current braking mechanism to function as described herein. Furthermore, by coupling the magnets 830 to the sheave 802, sheaves with different magnet strengths may be used as replacement parts to control the generated resistance force of the eddy current braking mechanism. For example, if a cable is steep and loads arrive at the terminal end with excessive speed, the sheaves 802 can be replaced on the trolley 800 for sheaves with stronger magnets. In this example, the sheaves 802 may include indicia (e.g., color coded, markings, etc.) based on the magnetic strength of the magnets 830 and the braking force generated.

It will be clear that the systems and methods described herein are well adapted to attain the ends and advantages mentioned as well as those inherent therein. Those skilled in the art will recognize that the methods and systems within this specification may be implemented in many manners and as such is not to be limited by the foregoing exemplified embodiments and examples. For example, the heat sink may be used across all of the trolley examples. In this regard, any number of the features of the different embodiments described herein may be combined into one single embodiment and alternate embodiments having fewer than or more than all of the features herein described are possible. It is to be understood that terminology employed herein is used for the purpose of describing particular examples only and is not intended to be limiting. It must be noted that, as used in this specification, the singular forms “a,” “an,” and “the” include plural referents unless the context clearly dictates otherwise.

While various embodiments have been described for purposes of this disclosure, various changes and modifications may readily suggest themselves to those skilled in the art and may be made which are well within the scope of the present disclosure.

What is claimed is:

1. A trolley comprising:
a housing;
at least one sheave rotatably mounted at least partially within the housing; and
a braking mechanism comprising:
a rotor assembly coupled to the at least one sheave;
at least one conductive element; and
at least one magnetic element, wherein the rotor assembly is rotatable with the at least one sheave, and wherein when the rotor assembly rotates, the at least one conductive element overlaps with the at least one magnetic element based at least in part on a rotational speed of the rotor assembly.

2. The trolley of claim 1, further comprising a sheave axle, wherein the sheave axle directly couples rotation of the at least one sheave to the rotor assembly.

3. The trolley of claim 1, further comprising a transmission coupled between the at least one sheave and the rotor assembly, wherein the transmission either increases or decreases the rotation of the rotor assembly from the rotation of the at least one sheave.

4. The trolley of claim 1, wherein the braking mechanism is at least partially disposed within the housing.

5. The trolley of claim 1, wherein at least a portion of the braking mechanism is disposed at least partially within the at least one sheave.

6. The trolley of claim 5, wherein the rotor assembly is disposed at least partially within the at least one sheave and comprises the at least one magnetic element.

7. The trolley of claim 6, wherein the housing comprises the at least one conductive element.

8. The trolley of claim 5, wherein the rotor assembly is disposed at least partially within the at least one sheave and comprises the at least one conductive element.

9. The trolley of claim 1, further comprising a heat sink.

10. The trolley of claim 1, wherein the rotor assembly comprises one or more pivoting arms having the at least one conductive element or the at least one magnetic element, and wherein the pivoting arms comprise one or more cavities defined therein.

11. The trolley of claim 1, wherein the rotor assembly comprises one or more pivoting arms having the at least one conductive element or the at least one magnetic element, and wherein the pivoting arms comprise one or more slots defined therein.

12. A trolley comprising:
a housing;
at least one sheave rotatably mounted at least partially within the housing; and
a braking mechanism comprising:
at least one magnetic element coupled to the at least one sheave, wherein the at least one magnetic element is rotatable with the at least one sheave; and
at least one conductive element disposed proximate the at least one magnetic element.

13. The trolley of claim 12, wherein the housing comprises the at least one conductive element.

14. The trolley of claim 12, wherein the at least one sheave comprises a plurality of circumferentially spaced cavities defined in a sidewall, and wherein each cavity of the plurality of cavities is sized and shaped to receive the at least one magnetic element.

15. The trolley of claim 14, wherein at least one cavity of the plurality of cavities is devoid of the at least one magnetic element.

16. The trolley of claim 14, wherein the at least one magnetic element comprises a first magnetic element and a second magnetic element, and wherein the first magnetic element has a greater magnetic strength than the second magnetic element.

17. The trolley of claim 14, wherein the plurality of cavities comprises a first cavity and a second cavity, and wherein the first cavity comprises a depth within the sidewall greater than a depth of the second cavity.

18. An eddy current braking mechanism comprising:
a structure comprising at least one conductive element or at least one magnetic element; and
a trolley configured to traverse along the cable, the trolley comprising:
a housing;
at least one sheave rotatably mounted at least partially within the housing; and
the other of the at least one conductive element or the at least one magnetic element, wherein the at least one conductive element is proximate the at least one magnetic element, when the trolley is installed onto the cable.

19. The eddy current braking mechanism of claim 18, wherein the trolley further comprises an adjustment device that selectively positions the at least one magnetic element relative to the at least one conductive element.

20. The eddy current braking mechanism of claim 18, wherein the at least one conductive element or the least one magnetic element is coupled to the structure.
